(19) United States
(12) Patent Application Publication
(10) Pub. No.: US 2010/0162916 A1
(43) Pub. Date: Jul. 1, 2010

(54) TRANSPORT SYSTEM

(76) Inventor: Alexander Lechner, Faak am See (AT)

Correspondence Address: YOUNG & THOMPSON, 209 Madison Street, Suite 500, Alexandria, VA, 22314, US

(21) Appl. No.: 12/601,457

(22) PCT Filed: May 8, 2008
(86) PCT No.: PCT/AT08/00160

§ 371 Date: Nov. 23, 2009

(30) Foreign Application Priority Data
May 22, 2007 (AT) A795/2007

(51) Int. Cl. B61K 1/00; B60L 13/04

(52) U.S. Cl. 104/20; 104/281

(57) ABSTRACT

A conveyor for medium distances has a track with at least two entry/exit points (1), by which cars (4-8) that can be run are run or moved continuously and rest snugly against one another as a footprint that is designed as a sector of a circle or a ring segment. The entry/exit points (1) are connected in two travel directions with one track that is usually designed from rails (2, 3), along which the cars (4-8) can be moved in an individually controlled manner by a drive. The running speed along the track is independent of that when moving through the entry/exit points (1). The conveyor therefore combines the advantages of continuously running conveyor belts with those of rapid transport tracks.

The invention relates to a conveyor with the features of the introductory part of claim 1. Such conveyors are necessary for carrying people over medium distances, for example in larger building complexes such as shopping centers, train stations, and airports, or else in pedestrian underpasses, passages and corridors. They make it easy for people to cover on foot distances of several hundred meters at an accelerated pace.

The known conveyors are either moving walkways or moving sidewalks or small trams and buses. Moving walkways or moving sidewalks are escalators—similar to continuously-running conveyor belts—that can run horizontally or else up/down. They have the advantage that they are continuously available. The running speed is limited to at most twice the speed of walking (about 8 km/hour), however, to ensure safe entry and exit. In particular during exiting from moving sidewalks, dangerous situations can arise if several individuals have formed groups while traveling on the moving sidewalk, since they slow down when exiting and therefore narrowly miss one another. Moving sidewalks are used exclusively indoors or at least in areas that are covered and protected from the effects of weather.

Depending on the design, trams or buses can clearly run more quickly, but are not continuously available, so that waiting times have to be tolerated. They are therefore usually used only over distances of at least 500 m and primarily outdoors. In general, they also require a significantly broader track or a more expensive rail infrastructure than a moving sidewalk.

Several attempts to find solutions for conveyors for medium distances for the above-mentioned areas of use are known from the literature. For example, WO 2005/051829 A proposes designing conveyor belts using an expensive mechanism for variable running speeds. Other publications (e.g., EP 0 015 581 A, U.S. Pat. No. 4,391,200, and JP-A-2000229775) deal with the possibility of replacing the continuous conveyor belt by movable cars or platforms. However, to date, no simple and accepted solution for the configuration of entry/exit points and for turn-around points could even be found for this approach.

The object of the invention is to indicate a conveyor, in particular for medium distances, which is continuously available, can be entered safely and in turn exited from safely, whose running speed is not restricted by the entry and exit, and that overcomes the above-mentioned drawbacks of the known prior art.

The object according to the invention is achieved with a conveyor with the features of claim 1.

Preferred and advantageous configurations of the invention are subjects of the subclaims.

The conveyor according to the invention has movable cars that are designed as mobile units or as platforms, which can move along a track enclosed therein, preferably formed by a rail section.

The cars that are used as mobile units in the system according to the invention can be open “platforms.”

The cars can be equipped with a single drive.

The cars are preferably equipped along their periphery with support walls or a railing and optionally with at least one (movable or pivotable) door.

The track that is designed as a rail section preferably has at least two turn-around points that are simultaneously entry/exit points. The turn-around points are connected to one another by one lane for each travel direction.

The track can be also be made with a more complex design (more than two turn-around points and entry/exit points).

The geometry (outline, footprint) of the cars of the conveyor according to the invention is preferably configured so that the cars can rest against one another snugly between the cars at the turn-around points in which the track is designed as a semi-circular track. This is achieved by having the footprint of the car essentially correspond to a sector of a circle or ring segment. An opening angle of the sector of 90° is preferred, since this simplifies the track guiding and the movements at the turn-around point. Other opening angles can also be present, however.

During operation of the conveyor according to the invention, in each case several—for example two or three—cars are (slowly) guided through the turn-around points or the entry/exit points with their lateral surfaces resting against one another. Thus, a safe entry and exit in the cars moving continuously and arranged in an arc is possible. The cars can be mechanically connected (coupled) to one another at turn-around points or entry/exit points or can be controlled by, e.g., maintaining a sensor-controlled contact pressure of the rear car on the front car. As a result, at the entry/exit point, a continuous sequence of cars is formed without gaps or intermediate spaces developing.

After leaving the entry/exit point, the cars are accelerated by a drive, such as, e.g., a linear motor, arranged in the car or its chassis or along the track. The cars can therefore negotiate the track at a speed that is independent of the speed of the cars in the area of entry/exit points and turn-around points and higher than this speed. Before reaching the next entry/exit point, the cars are again slowed down and guided onto cars traveling in front of them in such a way that they gently approach the latter until the cars abut snugly against the front cars.

All movements of the cars relative to the track, but also with respect to maintaining the necessary safety intervals between the cars and in particular approaching a front car at an entry/exit point, are preferably monitored by sensors or devices for the measuring of position, distance and speed and are controlled electronically. In addition, rubber stops for cushioning the movement of the cars can be applied to the cars.

Within the scope of the invention, it is also considered to move the cars at entry/exit points by means of drives that are applied in a stationary manner to the entry/exit points. This facilitates, for example, the stopping or slowing of the passage of the cars to enable the entry and exit of disabled individuals or children.

The cars of the conveyor according to the invention can be designed with, for example, driven and/or slowed-down rollers, which run on rails.

Also, however, contact-free processes for supporting and guiding cars, such as magnetic forces or air cushions, or a combination of these processes, can be used.

The support and guide rollers, magnetic bearings and other devices for transferring the weight of the car to the rails and for guiding the cars, hereinafter the “chassis,” are preferably attached at the corners of the car to ensure stable and reliable driving behavior. In a possible embodiment, this means that in each case, a front and a rear chassis are guided along a main rail and an inner chassis is run on an auxiliary rail. When entering a turn-around point, the translational movement of the car is deflected into a pivoting movement and in turn when leaving the turn-around point, there is a shift from the pivoting movement into a translational movement.

Here, it is to be noted that the front and rear chassis in the areas of the movement transition (translation-pivoting) run on various tracks so that in this embodiment, separate rail branches are advantageous.

In addition, in this embodiment, a mechanism is advantageously provided to select the correct rail branch (shunting mechanism), which preferably is applied either to the chassis or to the rails of the platforms.

This mechanism, optionally provided in the cars, for selecting the rail branch at turn-around points and entry/exit points can also be used to expand the conveyor to several tracks and to provide branch points between the tracks.

Also, it is possible to provide additional entry/exit points along the track in one or in both travel directions, whereby the latter are not necessarily designed as turn-around points but rather can be connected to the track by curved segments.

In another configuration of the invention, it is possible to run several tracks essentially in the shape of a star to an entry/exit position in each case, so that a conveyor with more than two turn-around points, which are connected to one another by a single track enclosed therein, exists.

The main rail of the conveyor according to the invention consists in a possible embodiment at the turn-around point that consists of straight branches for moving the cars in and out as well as arcs, along which the cars are rotated. The angle of the point of intersection between two rail branches is determined by the arrangement of the chassis and is therefore always smaller than the opening angle of the footprint of the car.

The travel direction of the cars (mobile units) as well as the direction of rotation of the cars at the entry/exit positions can be selected freely.

The conveyor according to the invention offers the possibility for safe entry and exit into/from slowly moving cars, which accelerate individually after leaving the entry/exit points and are slowed down again before reaching the next entry/exit point, so that they are gently brought in to the cars moving at the entry/exit point, whereby the cars slowly pass through the entry/exit point in a continuous assembly of cars.

The configuration of the track as well as the platforms and their chassis and drive of the conveyor according to the invention is possible in a variety of ways and is indicated only by way of example for possible embodiments of the invention.

Further details, advantages and features of the invention are produced from the description below of preferred embodiments based on the drawings. Here:

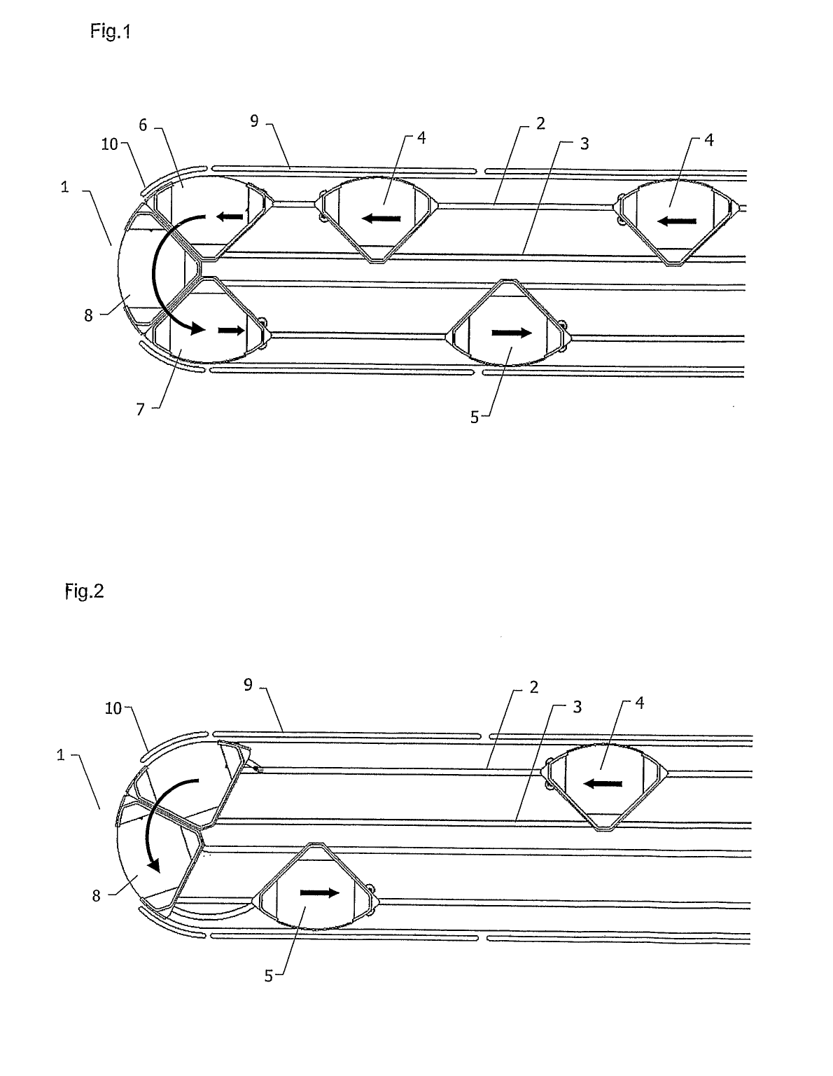

FIG. 1 shows schematically and partially in top view a conveyor in the area of a turn-around point;

FIG. 2 shows the conveyor of FIG. 1 with a car that exits from the turn-around point;

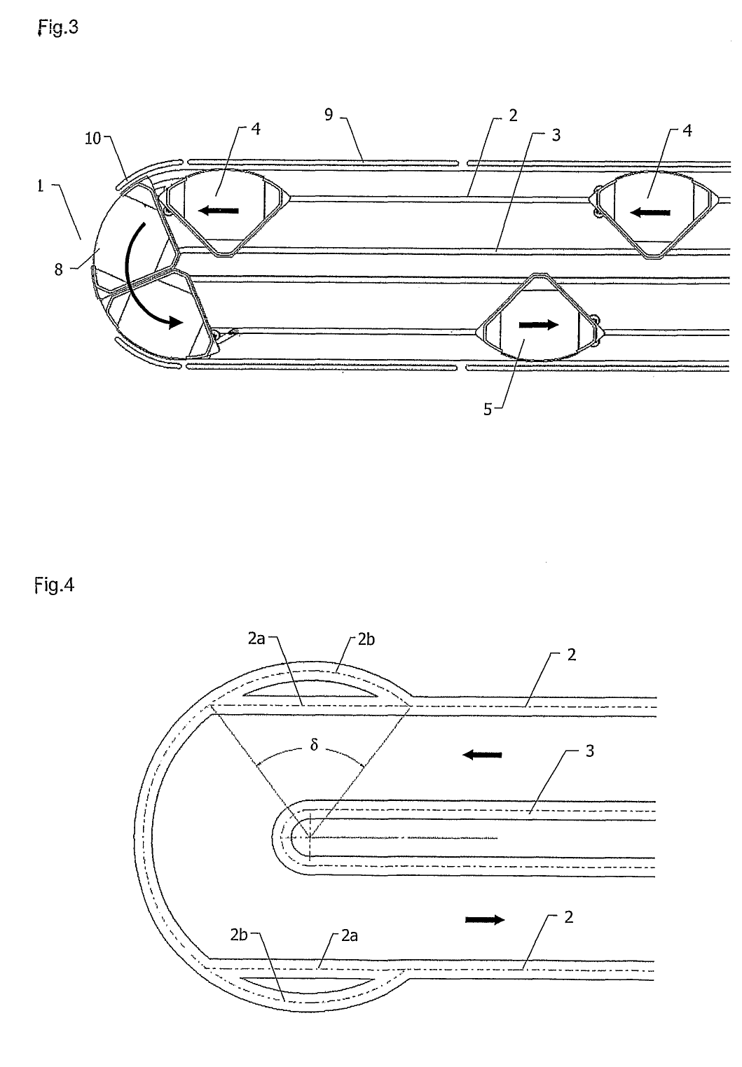

FIG. 3 shows the conveyor of FIG. 1 with a car that enters the turn-around point;

FIG. 4 in top view shows the arrangement of the rails at the turn-around point;

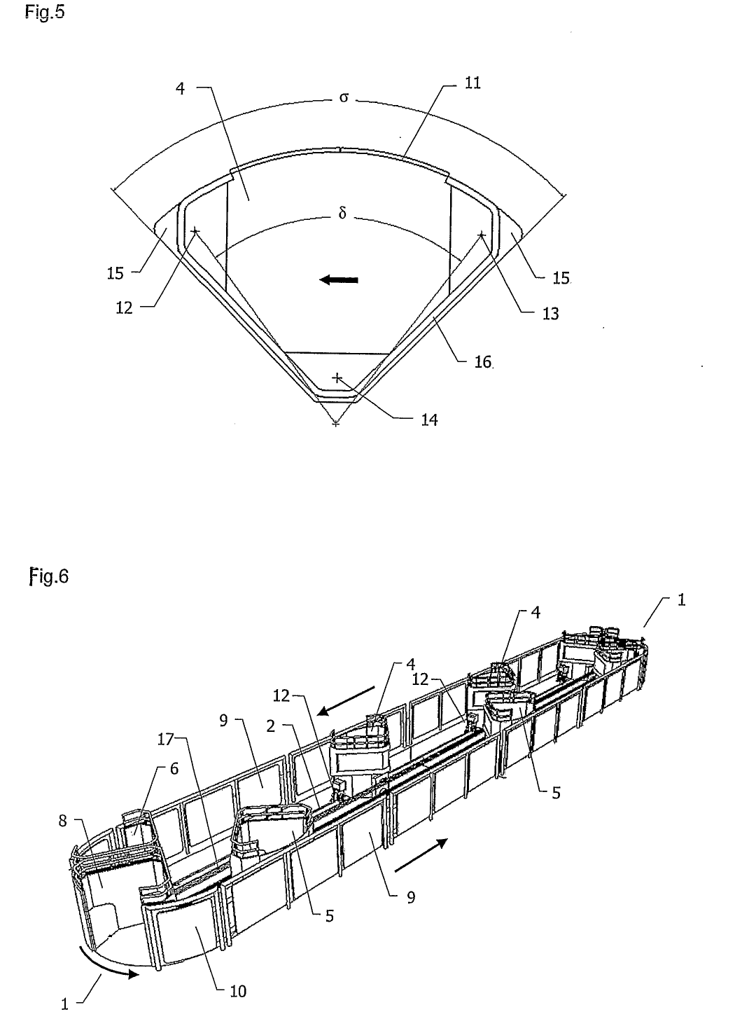

FIG. 5 in top view shows a car;

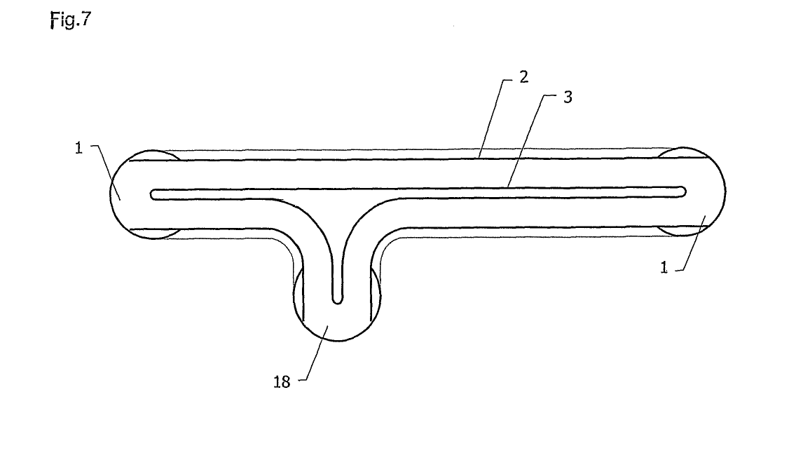

FIG. 6 in oblique view shows a conveyor; and

FIG. 7 shows another embodiment of a track.

In FIG. 1, a turn-around point of the conveyor, which is simultaneously entry/exit point 1, is shown. A mobile unit that is designed as a car 8, whose floor is even and snug with an entry or exit platform, which is adjacent to the outside of the track at the entry/exit point (not shown), just runs slowly through the entry/exit position 1 while executing a pivoting movement. Another car 6 just enters the entry/exit point 1, closes the gap to car 8 and shifts from a linear movement (translational movement) into a pivoting movement. Another car 7 leaves the entry/exit point 1 and shifts to a linear movement. Additional cars 4 and 5 travel to the entry/exit point 1 (station) or away from the latter. In the area of the entry/exit point 1, protective walls 10 are provided, which leave free any area in which the cars 6, 7 and 8 are (snugly) lined up and in which a safe entry and exit are possible. Additional protective walls 9 isolate the track from its surroundings.

The outline of the car (its footprint) is designed according to the type of a sector of a circle or a ring segment, whereby the radius of the outside circle of the footprint is identical to the outside radius of the track or the radius of the inside edge, adjacent to the track, of an outer boundary (platform) of the track at an entry/exit point 1 (turn-around point). Thus, it is achieved that the side of the car that lies outside of the entry/exit point 1 runs concentrically to the outside of the track, so that the cars can then be guided close to the entry/exit platform. By coordinating the radii of cars and tracks (at a turn-around point), the advantage is created that the front/rear sides of the cars remain essentially free of gaps or intermediate spaces when the cars move through an entry/exit point 1.

FIG. 2 shows the conveyor of FIG. 1 in a situation in which the car 5 that is leaving has already passed into a translational movement and travels to the next entry/exit point 1 (not shown).

FIG. 3 shows the situation in which a car 4 enters the entry/exit point 1 and in this case closes the gap with the car 8 that moves into the entry/exit point 1. As soon as the cars 4 and 8 with their lateral surfaces (essentially without gaps and intermediate spaces) rest against one another, the car 4 shifts into a pivoting movement and moves through the entry/exit point 1 along a circular track.

By way of example, FIG. 4 shows the arrangement of the rails and guideways in the area of the entry/exit point 1 designed as a turn-around point in the example. An outside rail 2, which carries the main load of the car, is divided at the turn-around point into partial loads 2a and 2b to make a track available to both a front chassis 12 and a rear chassis 13 of the car when shifting from the translational movement into the pivoting movement and vice versa. When entering the turn-around point, the front chassis 12 is driven along the straight partial load 21, and the rear chassis 13 is driven along the curved partial load 2b. When leaving, the chassis 12 takes on the curved partial load 2b, and the chassis 13 takes on the straight partial load 21.

An inside chassis 14 of the car is arranged in the center of the car and is therefore run or guided along the inside rail 3.

The angle δ, via which the outside rail 2 is divided into the partial loads 2a and 2b, is determined at the cars by the suspension points of the chassis 12 and 13. The shapes of the rails and the configuration of the branches are selected to match the respectively selected driving and guiding methods.

FIG. 5 shows a possible configuration of a mobile unit in the example of the car 4. The basic form (outline or footprint) of the car 4 corresponds to a circular section with an opening angle σ of 90°, whereby a (small) corner is cut into the center of the circular sector. The limiting of the standing room of the inner space (floor of the car) is carried out by protective walls 16, railings, etc., and can be offset—in particular in the area of the corners of the car 4—toward the inside from the edge of the floor.

In addition, the chassis 12, 13 and 14 are provided at the corners of the car below the floor.

To protect the passengers, the cars are equipped with doors 11 that are closed during travel.

On the lateral surfaces of the cars, in particular on the front and the rear corners, rubber stops 15 can be attached to ensure a soft “accumulation” of cars at the entry/exit points 1.

FIG. 6 shows a possible configuration of a conveyor according to the invention with two entry/exit points 1 and a closed track. The length of the section is to be larger than shown for usual applications, and it is possible, moreover, to run the section through curves and/or over split levels. The power supply of the cars is carried out by, for example, conductor lines 17.

FIG. 7 shows a configuration of a track by way of example with rails 2, 3 and with two entry/exit points 1 at the ends of the track as well as an additional entry/exit point 18 on one side of the track. In general, the two entry/exit points 1 are to be turn-around points.

In summary, one embodiment of the invention can be described as follows:

A conveyor for medium distances has a track with at least two entry/exit points 1, through which movable cars 4-8 are continuously driven or moved and which rest snugly against one another as a footprint that is designed as a sector of a circle or a ring segment. The entry/exit points 1 are connected in the two travel directions with a track that is usually composed of rails 2, 3 and along which the cars 4-8 can be controlled individually by a drive. The running speed along the track is independent of that when moving through entry/exit points 1. The conveyor therefore combines the advantages of continuously running conveyor belts with any rapid transport tracks.

1. Conveyors with several mobile units that are designed as cars (4-8) and with at least two entry/exit points (1), which are arranged along at least one track, on which the cars (4-8) are guided and that is formed for example from rails (2, 3), enclosed therein, characterized in that the cars (4-8) have a footprint that corresponds essentially to a sector of a circle or a ring segment.

2. Conveyor according to claim 1, wherein the entry/exit points (1) are simultaneously turn-around points for the cars (4-8).

3. Conveyor according to claim 1, wherein the cars (4-8) are moved through the entry or exit points (1) while executing a pivoting movement around a pivoting center that is found essentially in the center of the footprint of the car (4-8) that is in the shape of a sector of a circle or ring segment.

4. Conveyor according to claim 3, wherein the outer radius of the footprint of the car (4-8) is essentially the same size as the outer radius of the track or of the inner edge, adjacent to the track, of an outer boundary (platform) of the track at the entry/exit points (1).

5. Conveyor according to claim 1, wherein the cars (4-8) are moved through the entry/exit points (1) resting against one another with their lateral edges.

6. Conveyor according to claim 1, wherein the cars (4 to 8) are driven individually.

7. Conveyor according to claim 1, wherein the cars (4-8) are equipped with the chassis (12, 13, 14) with a power drive, for example consisting of driven or slowed rollers.

8. Conveyor according to claim 7, wherein the chassis (12, 13, 14) of the cars 4-8) are equipped with guide devices for following the track, for example with rollers running snugly on the rails (2, 3).

9. Conveyor according to claim 1, wherein the cars (4-8) are driven by a linear motor, which is arranged along the track.

10. Conveyor according to claim 1, wherein the cars (4-8) are held in a floating manner by magnetic forces and are guided along the track.

11. Conveyor according to claim 1, wherein the cars (4-8) are held in a floating manner by air cushions and are guided along the track.

12. Conveyor according to claim 1, wherein the cars (4-8) at the entry/exit points (1) are moved through via the entry/exit points (1) by several drives attached to platforms, which are provided in the area of the entry/exit points (1).

13. Conveyor according to claim 1, wherein the track in the area of the entry/exit points (1) has partial areas with branches (partial loads 2a, 2b), which make possible the shifting from a translational movement of the cars (4-8) into a rotational movement and vice versa.

14. Conveyor according to claim 1, wherein the track has branches to other tracks, which run to other entry/exit points (1).

15. Conveyor according to claim 1, wherein the cars (4-8) or the chassis (12, 13, 14) of the cars (4-8) have a device for selecting the track at the branching of rails (2, 3).

16. Conveyor according to claim 1, wherein the conveyor or the cars (4-8) are equipped with devices for measuring or monitoring the distance of the cars (4-8) from one another and for avoiding collisions of cars (4-8) that run behind one another.

17. Conveyor according to claim 2, wherein the cars (4-8) are moved through the entry or exit points (1) while executing a pivoting movement around a pivoting center that is found essentially in the center of the footprint of the car (4-8) that is in the shape of a sector of a circle or ring segment.

18. Conveyor according to claim 2, wherein the cars (4-8) are moved through the entry/exit points (1) resting against one another with their lateral edges.

19. Conveyor according to claim 3, wherein the cars (4-8) are moved through the entry/exit points (1) resting against one another with their lateral edges.

20. Conveyor according to claim 4, wherein the cars (4-8) are moved through the entry/exit points (1) resting against one another with their lateral edges.
